(19) United States
(12) Patent Application Publication
(10) Pub. No.: US 2003/0173923 A1
(43) Pub. Date: Sep. 18, 2003

(54) Windshield wiper system having vehicle speed-sensitive wiper delay

(76) Inventors: Joseph F. Nazione JR., Macomb, MI (US); Ronald Norman Schultz, Troy, MI (US); Garry F. Campbell, Detroit, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/097,391

(22) Filed: Mar. 13, 2002

(51) Int. Cl. H02P 1/00; H02P 3/00; G05B 5/00; H02P 7/00; H02H 7/08

(52) U.S. Cl. 318/447

(57) ABSTRACT

The windshield wiper system for use on a vehicle is capable of automatically adjusting the delay between consecutive cycles of a windshield wiper as a function of vehicle speed. The system includes at least one windshield wiper and a motor coupled to the windshield wiper for driving it. A sensor generates a signal corresponding to a measure of the vehicle's speed. A processor is coupled to the sensor and to the wiper motor and provides a drive signal to the wiper motor which is a function of the first signal.

### TECHNICAL FIELD

This invention relates generally to windshield wiper systems and more particularly to a windshield wiper system wherein the duration of the interval between successive sweeps of a windshield wiper is automatically adjusted in response to vehicle speed.

### BACKGROUND OF THE INVENTION

Manually-actuated selector mechanisms for altering the speed of windshield wipers are well known. If a vehicle is being operated in a light rain or drizzle, an operator of the vehicle might set the selector mechanism or switch to a “low” setting to keep the windshield clear while minimizing distractions to the driver due to unnecessary wiping. As a rainfall becomes heavier, the operator could manually select a “high” speed in order to enhance operator visibility.

More recently, an intermittent mode has been added to windshield wiper systems and has been utilized on many vehicles. In addition to the standard “low” and “high” settings, an intermittent wiper system provides for predetermined time delays between consecutive cycles or wipes (i.e., a forward wiping motion followed by a return wiping motion across the vehicle's windshield). Intermittent wiper systems generally provide several settings, which many be manually selected to provide a different delay time between successive wipes. For example, in a light mist, the operator may adjust the intermittent controller for a relatively long pause or delay between successive wipes, thus permitting moisture to accumulate on the windshield before wiping. When the precipitation is heavier, the intermittent controller may be adjusted for a shorter delay to prevent precipitation accumulation on the windshield from adversely impairing the driver's visibility.

One problem associated with intermittent windshield wiper systems is that they require constant adjustment by the vehicle's operator to meet changing driving conditions. For example, if the precipitation level increases, the driver's vision can be impaired if the delay is set too high (i.e., a lower wiper rate), allowing excessive moisture to accumulate on the windshield. In contrast, if the delay is too small (i.e., higher wiping rate) for a given amount of precipitation, the driver can be annoyed or distracted and the useful life of the wiper reduced. Even if the rate of precipitation remains relatively constant, more moisture will strike the vehicle's windshield as the speed of the vehicle increases. Thus, the amount of delay between successive wipes should be higher (i.e., a lower wipe rate) at low vehicle speed and lower (i.e., a higher wipe rate) at higher vehicle speeds.

Unfortunately, the process of adjusting the wiper delay is at best a trial-and-error process which can require frequent monitoring and adjustment by the driver which can be particularly time-consuming and distracting, even possibly leading to an accident. Adjusting the wiper delay may cause the driver to take his or her eyes off the roadway at a time when he or she should be particularly attentive to the road and the traffic thereon. Thus, it would be desirable to provide a windshield wiper system including an intermittent mode of operation wherein the delay between consecutive wipes is automatically adjusted based on the speed of the vehicle. Furthermore, additional desirable features will become apparent to one skilled in the art from the foregoing background of the invention and the following detailed description of a preferred exemplary embodiment and the appended claims.

### SUMMARY OF THE INVENTION

In accordance with the teachings of the present invention, there is provided a windshield wiper system for use on a vehicle and capable of automatically adjusting the delay between consecutive cycles of a windshield wiper as a function of vehicle speed. The system comprises at least one windshield wiper and a motor coupled thereto for driving the windshield wiper. A sensor generates a signal corresponding to a measure of the vehicle's speed. A processor coupled to the sensor and to the motor provides a drive signal to the motor which is a function of the signal corresponding to a measure of the vehicle's speed.

### BRIEF DESCRIPTION OF THE DRAWINGS

The present invention will hereinafter be described in conjunction with the appended drawing figures wherein like numerals denote like elements and

FIG. 1 is a block diagram of an inventive windshield wiper system;

FIG. 2 is a flow chart illustrating the process of adjusting the delay between successive sweeps of the windshield wiper as a function of vehicle speed; and

FIG. 3 is a table which is useful in explaining how the automatic adjustments to the delay between consecutive windshield wiper sweeps as a function of vehicle speed is also a function of an initial delay setting selected by the vehicle's driver.

### DESCRIPTION OF THE PREFERRED EMBODIMENT

The following detailed description of a preferred embodiment of the invention is mainly exemplary in nature and is not intended to limit the invention or the application or use of the invention.

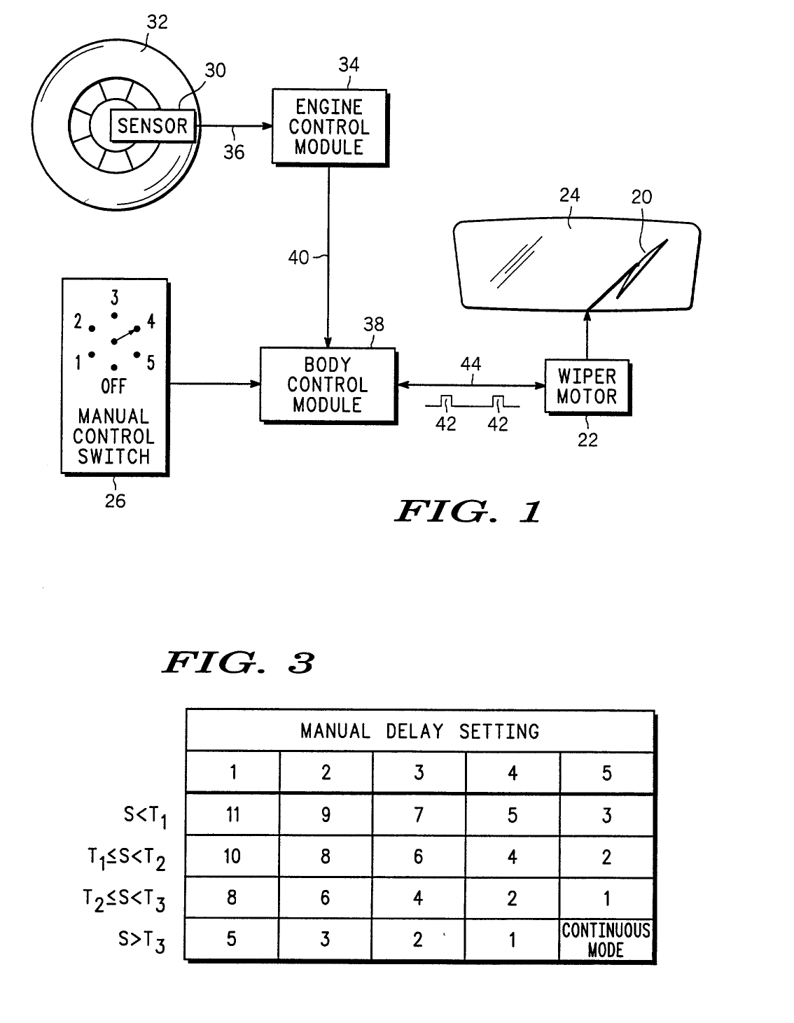

FIG. 1 is a block diagram of the inventive windshield wiper system. At least one windshield wiper 20 energized by wiper motor 22 is deployed to make multiple sweeping cycles known as wipes or sweeps over windshield 24 to remove moisture and/or debris therefrom. Wiper 20 and wiper motor 22 are of the type well known in the art. While only one windshield wiper 20 is shown in FIG. 1, it should be clear that a plurality of windshield wipers may be utilized on front and/or rear windshields of a vehicle.

A manual switch 26 is provided having an “off” setting and five operational settings 1, 2, 3, 4, and 5. Each operation setting corresponds to a different delay between consecutive sweeping cycles or wipes, each of which comprises a forward wiping motion following by a return wiping motion across windshield 24. Setting 1 corresponds to the longest delay between consecutive sweeping cycles, and setting 5 corresponds to the shortest delay. Thus, an operator of the vehicle might use setting 1 in a mist or light drizzle and progress through settings 2, 3, 4, and 5 as rainfall or other precipitation becomes heavier. For example, setting 1 may correspond to a delay of 11 seconds between wipes. The delay decreases, for example, to 9 seconds at setting 2, 7 seconds at setting 3, 5 seconds at setting 4, and 3 seconds at setting 5. Thus, manual control switch allows an operator to initially select a desired delay between consecutive wipes and therefore control the wipe rate in accordance with operator needs and weather conditions.

It is well known that modern vehicles are equipped with multiple onboard computers that control different aspects of a vehicle's operation; e.g., a module for engine control, a body control module that is typically responsible for controlling functions such as suspension, the information clusters on the vehicle's instrument panel, heating and air conditioning, etc. The inventive windshield wiper system shown in FIG. 1 includes an automatic delay adjustment mode of operation which involves a sensor 30 deployed proximate wheel 32. Engine control module 34 receives information relating to the speed of rotation of wheel 32 from sensor 30 over link 36. Engine control module 34 generates a signal which represents the vehicle's speed and provides that signal to body control module 38 via link 40. Body control module processes both the speed signal supplied via link 40 and the setting of manual control switch 26 in order to adjust the delay between consecutive wiper sweeps. That is, body control module 38 generates a series of pulses 42 which are transmitted to wiper motor 22 via line 44. Each pulse 42 initiates a wiper cycle or sweep which consists of a first movement forward across windshield 24 and then a return movement back to its park or rest position. Body control module 38 computes and inserts a delay between pulses 42 and therefore between consecutive wiper sweeps. Thus, engine control module 34 and body control module 38 act as a processor which receives the output of sensor 36 and monitors the position of manual control switch 26 to adjust the delay between consecutive sweeps or cycles of wiper 20 by controlling the delay between wiper motor drive pulses 42.

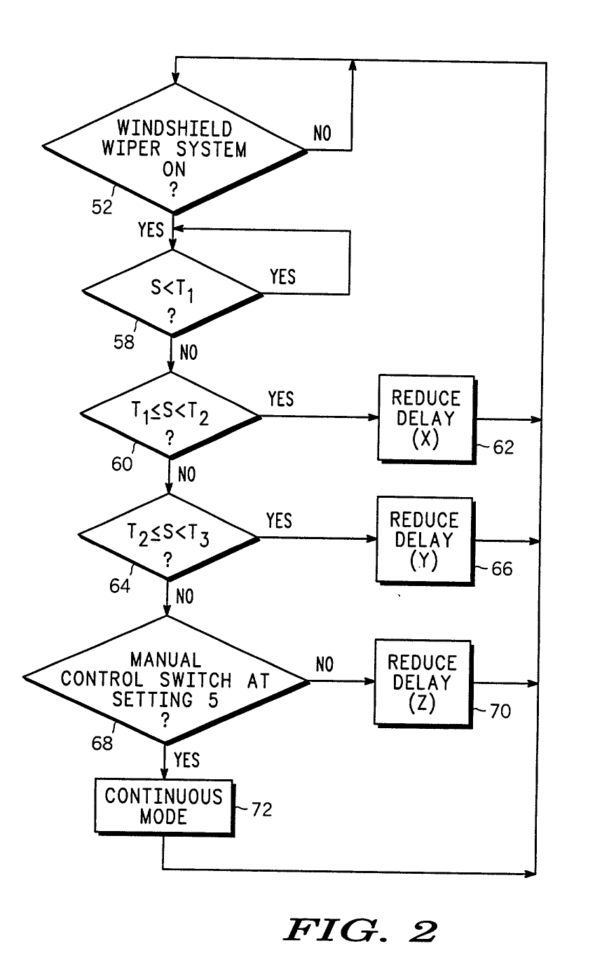

Referring to FIG. 2, the process for automatically adjusting the delay as a function of vehicle speed starts at 52 with a determination of whether or not the windshield wiper system is on. If so, the speed (S) of the vehicle, as supplied to body control module 38 by engine control module 34, is compared in body control module 38 to determine if the speed has reached a first predetermined speed threshold T₁ as is shown at 58. If the speed is less than T₁ (S<T₁), the delay between sweeps corresponds to the standard delays set by manual control switch 26 and shown in the row of FIG. 3 designated by S<T₁. The numbers in each box are examples of the delay in seconds corresponding to the delays assigned to each operational setting of manual control switch 26.

If the vehicle's speed (S) is greater than T₁, the process next asks if S is greater than or equal to T₁ but less than a second predetermined threshold T₂ (i.e., T₁ S<T₂) as is shown at 60. If so, the delay between consecutive sweeps is reduced by a predetermined amount X (shown at 62) which is different depending on the setting of manual control switch 26 as will be more fully described in connection with FIG. 3. If the speed of the vehicle is not less than the second predetermined threshold T₂, the process next asks if S is greater than or equal to T₂ but less than a third predetermined threshold T₃ as is shown at 64. If so, the delay is reduced at 66 by a predetermined amount Y which likewise depends on the setting of manual control switch 26.

If the vehicle's speed is greater than T₃, the system examines the setting of manual control switch 26. If the manual control switch is at setting 1, 2, 3, or 4, the system reduces the delay between consecutive sweeps by a predetermined amount Z shown at 70 which depends on the setting of manual control switch 26. If the manual control switch is at setting 5 corresponding to the shortest wipe delays, the system goes into a continuous wiper mode as shown at 72 with no delay time between consecutive sweeping cycles. As the vehicle's speed decreases, the process can be reversed with corresponding increases in the delay between consecutive sweeps as the speed falls below the various speed thresholds described above.

Referring now to FIG. 3, there is shown a table which illustrates how the delays between consecutive sweeps of the windshield wiper 20 vary as a function of vehicle speed (S) and the setting of manual control switch 26. The five columns of FIG. 3 correspond to the five manual settings of manual control switch. Setting 1 has the longest delay between consecutive wipes (lowest wipe rate), and setting 5 has the shortest delay between consecutive wipes (highest wipe rate). Row 1 (S<T₁) represents a situation when the vehicle's speed is less than the first predetermined threshold T₁ (e.g., 32 kilometers per hour). The delays associated with setting 1, 2, 3, 4, and 5 are 11 seconds, 9 seconds, 7 seconds, 5 seconds, and 3 seconds, respectively—the same as if auto delay switch 28 were off and the delays were being governed only by the manual settings of manual control switch 26. When the vehicle speed reaches T₁ but is less than T₂ (T₁ S<T₂), the delays are reduced to 10 seconds, 8 seconds, 6 seconds, 4 seconds, and 2 seconds, respectively, as is shown in the second row of FIG. 3. When the vehicle (S) reaches T₂ (e.g., 64 kilometers per hour) but is less than T₃ (e.g., 80 kilometers per hour) (T₂ S<T₃), the delays are reduced to 8 seconds, 6 seconds, 4 seconds, 2 seconds and 1 second, respectively, as is shown in the third row of FIG. 3. When the vehicle's speed (S) exceeds T₃ (S>T₃), delays are further reduced to 5 seconds, 3 seconds, 2 seconds, and 1 second for switch settings 1, 2, 3, and 4, respectively, as is shown in the fourth row of FIG. 3. However, when S>T₃ and manual control switch 26 is at setting 5, further reductions are not possible due to the inherent electrical and mechanical limitations of the system. Therefore, the system enters continuous mode with no delay between consecutive sweeps.

It should be clear that the number of thresholds (T₁, T₂, and T₃), the values of the thresholds (32 kilometers per hour, 64 kilometers per hour, and 80 kilometers per hour, respectively), the number of manual control switch settings (1, 2, 3, 4, and 5), and the specific delays shown in FIG. 3 are given by way of example. Each of these parameters can be modified to achieve desired results.

From the foregoing description, it should be appreciated that methods and apparatus are provided for providing a windshield wiper system which automatically adjusts the delay between consecutive sweeps of a wiper as a function of vehicle speed. While a preferred exemplary embodiment has been presenting in the foregoing detailed description, it should be appreciated that a vast number of variations in the embodiments exist. It should also be appreciated that this preferred exemplary embodiment is only an example, and is not intended to limit the scope, applicability, or configuration of the invention in any way. Rather, the foregoing detailed description provides one skilled in the art with a convenient roadmap for implementing a preferred exemplary embodiment of the invention. It should be understood that various changes may be made in the function and arrangement of elements described in the exemplary preferred embodiment without departing from the spirit and scope of the invention as set forth in the appended claims.

1. A windshield wiper system for use on a vehicle and capable of automatically adjusting the delay between consecutive cycles of a windshield wiper as a function of vehicle speed, comprising;
at least one windshield wiper;
a motor coupled to said at least one windshield for driving said at least one windshield wiper;
a sensor for generating a signal corresponding to a measure of the vehicles speed; and
a processor coupled to said sensor and to said motor for providing a drive signal to said motor which is a function of said first signal.

2. A windshield wiper system according to claim 1 wherein said drive signal comprises a plurality of pulses each for initiating repeatedly one of a plurality of cycles of said windshield wiper.

3. A windshield wiper system according to claim 2 wherein a delay between consecutive ones of said plurality of cycles is varied as a function of the speed of the vehicle.

4. A windshield wiper system according to claim 3 further comprising a manual selector for enabling an initial selection of said delay.

5. A windshield wiper system according to claim 4 wherein said manual selector includes a plurality of settings corresponding to delays of different duration.

6. A windshield wiper system according to claim 3 wherein said computer system automatically reduces said delay by a first predetermined amount when the speed of said vehicle reaches a first predetermined threshold.

7. A windshield wiper system according to claim 6 wherein said computer system automatically further reduces said delay by a second predetermined amount when the speed of said vehicle reaches a second predetermined threshold.

8. A windshield wiper system according to claim 7 wherein said computer system automatically still further reduces said delay when the speed of said vehicle reaches a third predetermined threshold.

9. A windshield wiper system according to claim 4 wherein said computer system automatically reduces said delay by a first predetermined amount when the speed of said vehicle reaches first predetermined threshold.

10. A windshield wiper system according to claim 9 wherein said first predetermined amount varies as a function of said initial setting.

11. A windshield wiper system according to claim 3 wherein said vehicle includes a wheel, said sensor is deployed proximate said wheel, and wherein said first signal is a function of the speed of rotation of said wheel.

12. A windshield wiper system according to claim 11 wherein said computer system comprises:
a first computer coupled to said sensor for receiving said first signal and for generating therefrom a second signal corresponding to the speed of the vehicle; and
a second computer coupled to said first computer and to said manual selector for receiving said second signal and an indication of said initial selection and for adjusting said delay in response thereto.

13. A windshield wiper system for use on a vehicle capable of automatically adjusting the delay between consecutive cycles of a windshield wiper as a function of the vehicle's speed, comprising:
at least one windshield wiper;
a motor coupled to said at least one wiper for driving said at least one windshield wiper;
a sensor for generating a first signal corresponding to a measure of the vehicle's speed; and
a processor coupled to said sensor and to said motor for providing a plurality of pulses to said motor, each of said plurality of pulses for initiating a cycle of said at least one windshield wiper, said processor reducing the delay between consecutive cycles by a first predetermined amount when the vehicle's speed reaches a first predetermined threshold.

14. A windshield wiper system according to claim 13 further comprising a manual selector for enabling an initial selection of said delay.

15. A windshield wiper system according to claim 14 wherein said manual selector includes a plurality of settings corresponding to delays of different duration.

16. A windshield wiper system according to claim 15 wherein said computer system automatically further reduces said delay by a second predetermined amount when the speed of said vehicle reaches a second predetermined threshold.

17. A windshield wiper system according to claim 16 wherein said first predetermined amount and said second predetermined amount vary as a function of said initial selection.

18. A method for automatically adjusting the delay between successive cycles of a windshield wiper as a function of vehicle speed comprising:
generating a first signal indicative of the vehicle's speed;
energizing a wiper motor with a plurality of pulses, each pulse initiating a different one of said cycles; and
varying the delay between said cycles as a function of said first signal.

19. A method according to claim 18 further comprising the step of reducing the delay between said cycles when the vehicle's speed reaches a first predetermined threshold.

20. A method according to claim 19 further including the step of reducing further the delay between said cycles when the vehicle's speed reaches a second predetermined threshold.
